(19) United States
(12) Patent Application Publication
(10) Pub. No.: US 2025/0061822 A1
(43) Pub. Date: Feb. 20, 2025

(54) SMART NAME BADGE

(71) Applicant: Austin NADIN, Wexford, PA (US)

(72) Inventor: Austin NADIN, Wexford, PA (US)

(21) Appl. No.: 18/805,901

(22) Filed: Aug. 15, 2024

Related U.S. Application Data
(60) Provisional application No. 63/520,212, filed on Aug. 17, 2023.

(51) Int. Cl. G09F 3/20

(52) U.S. Cl. CPC G09F 3/208; G09F 3/207

(57) ABSTRACT

A smart name badge system is encoded with participant-selected answers to several questions. When activated by the wearer, an initiating smart name badge elicits responses from other badges within a physical range. The degree of congruence between the initiating smart name badge and each responding badge is assessed and the responding badge having the most significant match quotient is determined. The person associated with the matching responding badge is identified on the initiating badge to prompt an in-person connection.

### FIELD OF THE INVENTION

The present disclosure is generally directed to a smart name badge to connect people at events based on chosen criteria.

### BACKGROUND OF THE INVENTION

Current solutions for connecting people at events do not have an acceptable way for the user to initiate the connection. There is a smart name badge called Proxfinity that connects and uses 4 lights to show preferences based exclusively on proximity. Each light and color corresponds to a question and answer, respectively. US Patent Publication No. US-20130282818-A1 and U.S. Pat. Nos. 8,417,777-B2 and 9,172,725-B2 disclose these known badge technologies. These patents and publications are incorporated by reference in their entirety. There is also a wristband called Sparkwear that connects devices based exclusively on proximity. U.S. Patent Publication US-20210235568-A1 and U.S. patent Ser. No. 11/452,193-B2 disclose these wristband technologies. These patents and publications are incorporated by reference in their entirety. These solutions are limited and do not provide sufficient information to provide a connection for people at conferences.

Through concept testing it is found that the experience of using connection technologies as part of a mobile app is lacking. Event/conference mobile apps are known, but they do not pair users based on user-designated criteria. Additionally, people may prefer user engagement to start a connection, almost akin to being introduced to someone.

What is needed is a smart name badge to connect people at events based on their answers to a set of questions. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The purpose of the invention is to break the ice or start interactions with people at conferences where not everyone knows each other. More particularly, the subject matter of this application pertains to devices and methods of identifying individuals who share common interests and who are seeking to meet appropriate people at an event such as a conference. Even more particularly, the subject matter of this application prompts the in-person meeting of identified persons.

The subject matter of this application utilizes a name badge. Each name badge is loaded with wearer's preferences. There is a button on the name badge that initiates an encounter. Once the button is pressed the name badge identifies the name badge with the most preferences in common within a distance range. A screen on the badge then displays the name of the identified person and at least one of the preferences that the persons have in common.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE ILLUSTRATIONS

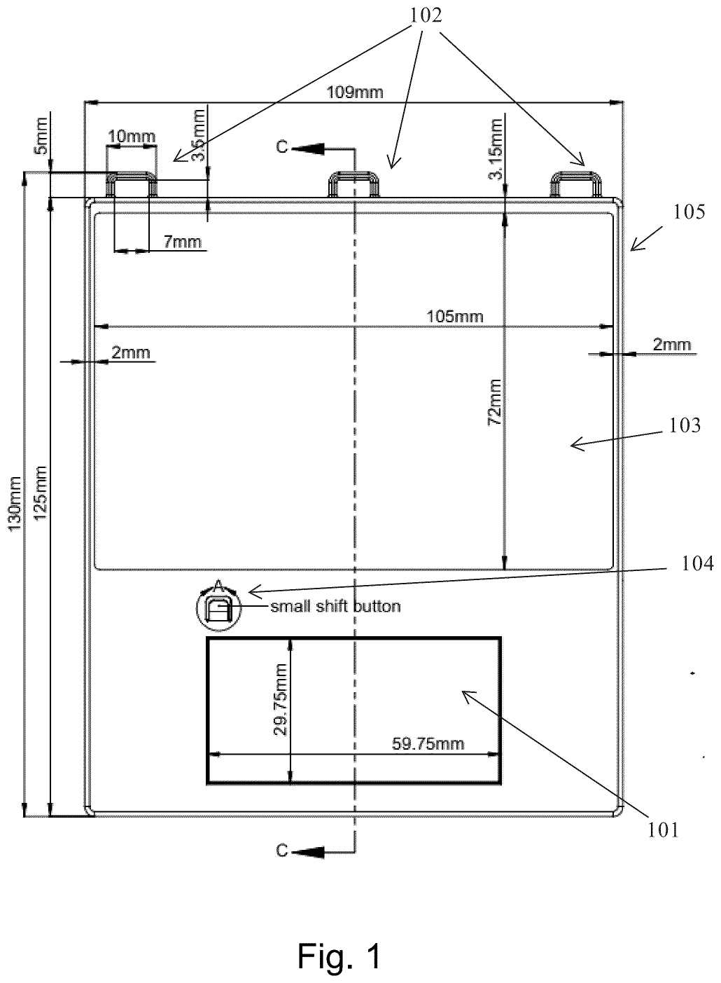

FIG. 1 is an illustration of a smart name badge including preferred sizing information.

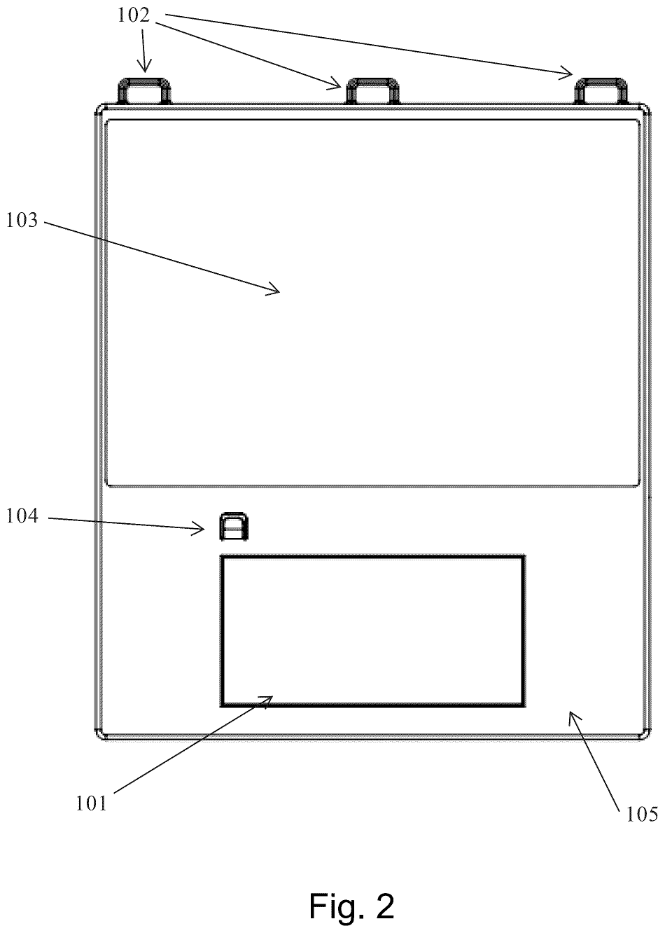

FIG. 2 is an illustration of a smart name badge without preferred sizing information.

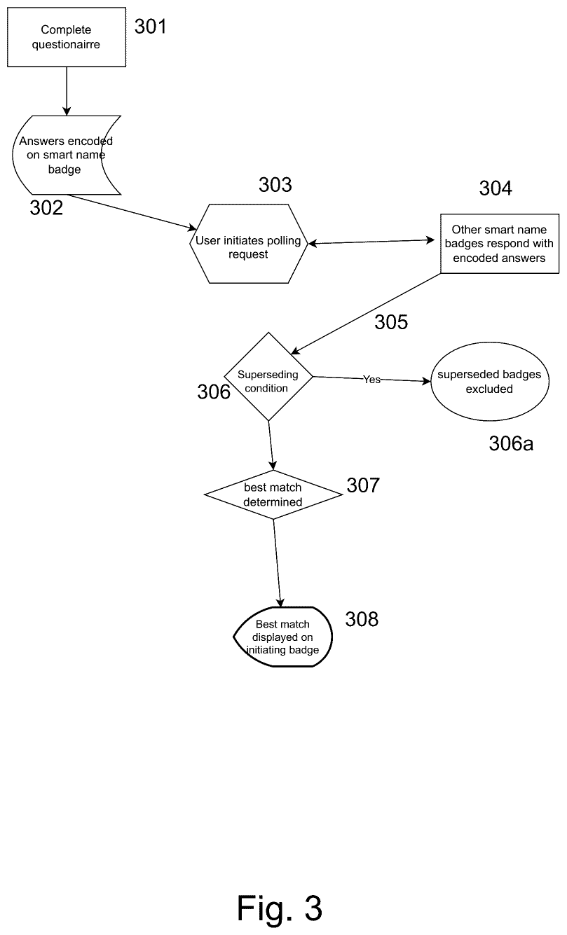

FIG. 3 is a flowchart illustrating the disclosed method of matching wearers of smart name badges.

### DETAILED DESCRIPTION OF THE INVENTION

The badge is comprised of a development board (internal, not shown), a screen (101), a battery (internal, not shown), lanyard attachment points (102), a static placard (103), a button (104), and a housing unit (105).

The components may be custom built for use with the subject matter of this application or may be an appropriate “off-the-shelf” solution such as, e.g., a Raspberry Pi. The badge contains a rechargeable battery. The development board, screen, and battery are within a housing unit. The housing unit comprises holes (102) for lanyards to be attached and a raised portion that acts as a button to initiate connections. The development board is adapted to store and act upon at least three sets of information: the match criteria, preferences pertaining to how badges interact, and a logo. In most embodiments, the static placard (103) displays information about the wearer as is standard for typical name badges, i.e., things such as name, title, employer, as appropriate. The screen (101) displays non-static information. In a most highly preferred embodiment, the screen would display a logo or similar indicia when the wearer is unmatched, but when the wearer matches with another as described herein, the display would indicate the bearer of the matching smart name badge by name to prompt interaction.

In a most highly preferred embodiment names and preferences of attendees of events are gathered before the event when they register or as they check in at the event. An alternative embodiment may involve an app or link that could be tied to each specific name badge.

In some embodiments the information may be stored locally administered by the event organizer.

When activated by a wearer, an initiating name badge (303) sends out a signal to all other proximal name badges eliciting a response. All the nearby answering name badges (e.g., 304) then send a signal (305) to the initiating name badge with their preferences. Each name badge may be both an initiating and an answering badge and multiple signals may be sent and received nearly simultaneously. The distinction is made here merely to simplify drafting and understanding.

The degree of similarity between the initiating and answering smart name badges are determined (307) and the person with the highest degree of answer similarity will be indicated to the wearer of the initiating name badge (308). Preferably, the wearer of this answering name badge will have their name and some indication of their matching qualities displayed on the initiating badge prompting the two wearers to meet.

More specifically, the wearer completes a preference survey (301) which is encoded (302) onto the development board of their name badge. The number of questions may vary and the complexity of the answers may depend on the available computing power. In a most highly preferred embodiment, there are five questions, and each question has up to ten options. In addition to the five questions, there is at least one superseding or threshold question or condition that prevents repeated matches with the same wearer. Another optional superseding question matches groups. For example, this superseding condition may be used to ensure that job seekers will only match with people who are hiring or to ensure that graduating students only match with appropriate professionals.

In this embodiment, each digit of the five-digit code corresponds to an answer. For example, if one selects the fifth answer to question 1, the third answer to question 2, the second answer to question 3, the second answer to question 4 and the ninth answer to question 5, the five-digit code would be 53229. In use, the wearer of the initiating badge would initiate a name badge search by, e.g., pressing a button (104) on the name badge (303), nearby answering badges that satisfy the superseding question or questions would send their five-digit code to the initiating badge (304), while badges filtered out by the superseding question(s) are temporarily omitted (306a). The answering badge that is the best match with the initiating badge would be identified (307), and the initiating badge would display at least one of the matched preferences and prompt an introduction (308).

In a preferred embodiment the screen is 4 inches wide and 3 inches tall and capable to displaying multiple colors although other embodiments such as a LilyGo board with a 2.13 inch diagonal e-paper screen are also suited for use.

In most preferred embodiments, the name badges will interact with other name badges within about 10-15 feet (roughly 3-4.5 meters). The range ensures that users who match are fairly near to each other. It also prompts users to move about the event to find as many matches as possible. This movement also increases the opportunity for interactions with those who might not be good matches but may still be interesting and valuable contacts.

In another embodiment, the smart name badge includes a haptic feedback motor to let someone know that they have a connection. The smart name badge may also have the ability to connect to an app to load preferences via, e.g., a QR code.

In some embodiments, details of each match are saved and can be later reviewed by the wearer to allow for later follow-up with new contacts.

While the exemplary embodiments illustrated in the figures and described herein are presently preferred, these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A method of making highly relevant contacts at an event comprising the steps of:
a. Obtaining a questionnaire comprising a number of questions, each having one or more answers;
b. Having the answers to each question encoded on a name badge;
c. Wearing the name badge in the presence of others within a physical distance wearing similar name badges;
d. Initiating a contact protocol in which a name badge emits a signal indicating receptiveness to receive previously encoded answers;
e. Receiving encoded answers from badges worn by others;
f. Disregarding answers from those badges that fail to satisfy a superseding condition;
g. Identifying the answering badge with the greatest congruity of answers as the initiating name badge; and
h. Displaying identifying information for the wearer of the identified answering badge on the initiating name badge.

2. The method of claim 1 in which the number of questions is five and in which each of the five questions has up to 10 answers.

3. The method of claim 1 in which the name badge is comprised of computer hardware and software, adapted to perform the required actions.

4. The method of claim 2 in which the answers to the five questions are encoded in a five-digit number.

5. The method of claim 1 in which the physical distance is approximately 15 feet.

6. The method of claim 1 in which the superseding condition is whether the badges have previously matched within a set time frame.
